(19) United States
(12) Patent Application Publication
(10) Pub. No.: US 2022/0337626 A1
(43) Pub. Date: Oct. 20, 2022

(54) PROTOCOL DIALECT SCHEME FOR SECURITY IN SYSTEM CONNECTED TO NETWORK

(71) Applicant: Korea Advanced Institute of Science and Technology, Daejeon (KR)

(72) Inventors: BrentByungHoon KANG, Daejeon (KR); Seungyeop LEE, Daejeon (KR); Changil LIM, Daejeon (KR)

(21) Appl. No.: 17/374,084

(22) Filed: Jul. 13, 2021

(30) Foreign Application Priority Data
Apr. 16, 2021 (KR) 10-2021-0049779

(51) Int. Cl. H04L 29/06

(52) U.S. Cl. CPC H04L 63/166; H04L 63/0823; H04L 63/20; H04L 63/0272; H04L 63/0435; H04L 69/08

(57) ABSTRACT

Disclosed is a protocol dialect scheme for security in a system connected to a network. A protocol dialect method for security includes receiving, from a client, a message to which a protocol dialect has been applied at the start timing of a protocol and authenticating the received message based on the protocol dialect applied to the received message.

### CROSS-REFERENCES TO RELATED APPLICATIONS

This application is based on and claims priority under 35 U.S.C. 119 to Korean Patent Application No. 10-2021-0049779, filed on Apr. 16, 2021 in the Korean intellectual property office, the disclosures of which are herein incorporated by reference in their entireties.

### TECHNICAL FIELD

The following description relates to a technology for protecting a computing system, which is connected to a network and performs cross certification between a client and a server.

### BACKGROUND OF THE INVENTION

Transport layer security (TLS) and secure sockets layer (SSL) are encryption security protocols that provide Internet communication security, and may use an asymmetrical encryption scheme for a certification and key exchange and use a symmetrical encryption scheme for confidentiality. In particular, the TLS may be an IETF standard protocol defined in RFC 5246, RFC 6176, etc.

Conventionally, in client-server computing system, when communication is performed between a client and a server based on a security protocol (TLS), there are problems in that messages need to be transmitted and received several times between the server and the client at the start stage of the security protocol and compatibility with the existing network stack is not guaranteed due to a field added to the message, etc.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An object of the present disclosure is to provide a method and system for providing an additional security function by authenticating whether a protocol is executed normally based on a protocol dialect modification by using the first message of a client, while maintaining compatibility with various transport layer and application layer protocols operating based on the Internet protocol (IP) in a client-server environment.

In one aspect, a protocol dialect method for security performed by a protocol dialect system may include receiving, from a client, a message to which a protocol dialect has been applied at communication start timing of a protocol, and authenticating the received message based on the protocol dialect applied to the received message.

Receiving the message may include obtaining information for the application of the dialect by deriving a certification value or pattern information through at least one method by using a dialect key previously shared between the client and a server.

In the case of a transport layer security (TLS) protocol, client random field information which is information necessary to calculate a disposable symmetric key to be used between the client and the server is configured in the message transmitted by the client at the communication start timing, and receiving the message may include determining whether to execute a protocol execution process at the communication start timing of the client by using the configured random field information as the information for the application of the dialect.

In the case of a transport layer security (TLS) protocol, session ID field information for determining whether to reuse a session used between the client and the server is configured in the message transmitted by the client at the communication start timing, and receiving the message may include determining whether to execute a protocol execution process at the communication start timing of the client by using the configured session ID field information as the information for the application of the dialect.

In the case of a transport layer security protocol, receiving the message may include applying client certification to the message, transmitted by the client at the communication start timing, at the communication start timing of the client by using, as the information for the application of the dialect, order information of encryption algorithm proposal fields preferred by the client.

In the case of an IPSec VPN, Internet key exchange messages are exchanged in order to determine an encryption key to be used between the client and the server, and receiving the message may include applying client certification at the communication start timing of the client by using nonce information which is information necessary to determine an encryption key, as the information for the application of the dialect.

In the case of an IPSec VPN, a vendor ID payload is defined so that software or hardware vendors are capable of identifying IKE messages transmitted and received in systems of the vendors, and receiving the message may include applying client certification at the communication start timing of the client by using the defined vendor ID payload as the information for the application of the dialect.

In the case of an IPSec VPN, receiving the message may include applying client certification at the communication start timing of the client by using payload order information of IKE messages as the information for the application of the dialect.

In the case of an application layer protocol (hypertext transfer protocol (HTTP)), receiving the message may include applying client certification at the communication start timing of the client by using, as the information for the application of the dialect, order information of a plurality of header fields included in a request message transmitted by the client.

The protocol dialect method may further include providing a result value obtained by using the dialect key shared between the client and the server as an input to a cryptological function or an input to a function for generating order or progression so that the result value is used in receiving the message and authenticating the received message.

Authenticating the received message may include authenticating whether the client performs a normal protocol by comparing information for the application of the dialect obtained using a dialect key previously shared between the client and a server with a result expected from the message transmitted by the client.

Authenticating the received message may include protecting the received message against an external factor or an attacker in a communication path by using any one of an additional protection scheme using the received message and a message field of a lower communication layer including the received message, an additional protection scheme using a counter value synchronized between the client and the server, or an additional protection scheme of generating an authentication value by using a communication protocol and characteristics in a path.

Authenticating the received message may include generating, on a one off basis, a message to which each protocol dialect has been applied by synchronizing a maximum number of uses and a current number of uses of the dialect key shared between the client and the server.

Authenticating the received message may include checking field information of the message transmitted by the client at the communication start timing and a hash value of TCP/IP packet header information.

Authenticating the received message may include separating the received message from a dialect key previously shared between the client and a server by using a technology for a trusted execution environment, and protecting the received message.

A computer program stored in a computer-readable storage medium in order to execute a protocol dialect method for security performed in a protocol dialect system may include receiving, from a client, a message to which a protocol dialect has been applied at start timing of a protocol, and authenticating the received message based on the protocol dialect applied to the received message.

A protocol dialect system for security may include a message reception unit configured to receive, from a client, a message to which a protocol dialect has been applied at start timing of a protocol, and an authentication unit configured to authenticate the received message based on the protocol dialect applied to the received message.

The protocol dialect system may further include a derivation unit configured to obtain information for the application of the dialect by deriving a certification value or pattern information through at least one method by using a dialect key previously shared between the client and a server.

The protocol dialect system may further include a protection unit configured to protect the received message against an external factor or an attacker in a communication path by using any one of an additional protection scheme using the received message and a message field of a lower communication layer including the received message, an additional protection scheme using a counter value synchronized between the client and the server, or an additional protection scheme of generating an authentication value by using a communication protocol and characteristics in a path.

The protocol dialect system may further include a key protection unit configured to separately protect a dialect key previously shared between the client and a server by using a technology for a trusted execution environment.

The occurrence of a potential security weak point which may lead to a leakage accident of data can be prevented by determining whether a protocol is executed based on a dialect modification by using only the first message transmitted by a client at communication start timing.

A change in the system can be minimized and a security risk can be reduced by introducing an additional certification layer because a protocol dialect can be freely set in some of or the entire first message transmitted by a client among several types of protocols operating on the IP.

A change in the existing network configuration and costs attributable to compatibility with the existing protocol can be minimized.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram for describing a message exchange process in an embodiment.

FIG. 2 is a block diagram for describing a configuration of a protocol dialect system in an embodiment.

FIG. 3 is a flowchart for describing a protocol dialect method for security in an embodiment.

FIG. 4 is a diagram for describing a process of applying, by a client, a protocol dialect to a message in an embodiment.

FIG. 5 is a diagram for describing a process of applying, by a client, a protocol dialect to a message in an embodiment.

FIG. 6 is a diagram for describing a process of applying, by a client, a protocol dialect to a message in an embodiment.

FIG. 7 is a diagram for describing a process of applying, by a client, a protocol dialect to a message in an embodiment.

FIG. 8 is a diagram for describing a process of applying, by a client, a protocol dialect to a message in an embodiment.

FIG. 9 is a diagram for describing an operation of generating, by a client, a message in an embodiment.

FIG. 10 is a diagram for describing an operation of authenticating, by a server, a message in an embodiment.

FIG. 11 is a diagram for describing an operation of protecting a message against an external factor or an attacker in a communication path in an embodiment.

FIG. 12 is a diagram for describing an operation of protecting a message against an external factor or an attacker in a communication path in an embodiment.

FIG. 13 is a diagram for describing an operation of protecting a previously shared dialect key against a user, server management or other factors in an embodiment.

### DETAILED DESCRIPTION

While illustrative embodiments have been illustrated and described, it will be appreciated that various changes can be made therein without departing from the spirit and scope of the invention.

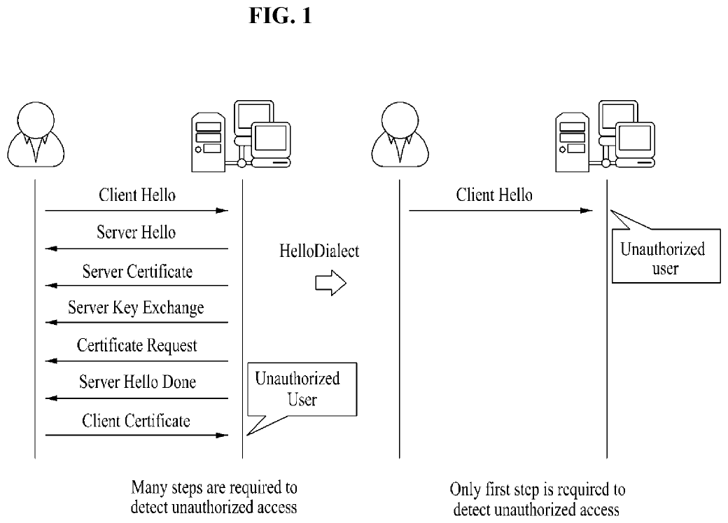

FIG. 1 is a diagram for describing a message exchange process in an embodiment.

In an embodiment, in general, a protocol dialect modification may be applied to a protocol that defines a field or message format configurable in the first message (“Hello message”) transmitted from a client to a server at communication start timing. Examples of such a protocol include Internet key exchange (IKE) (IPSec VPN), TLS/SSL, a hypertext transfer protocol (HTTP), etc., which may also be easily applied to other protocols. An added protocol dialect modification is perfectly compatible with the specification of a standard protocol. Accordingly, a change in already installed other network components, such as a router, other than a change in the software or hardware of a communication executioner between ends is not necessary.

For example, an encryption protocol (IKE for IPsec VPN, TLS/SSL, etc.) is described. The encryption protocol performs encryption on communication contents in order to prevent an invasion, such as wiretapping or falsification which may occur in a communication process. In this case, a key necessary for an encryption task may be determined by an initialization message exchange between a server and a client, which is called “handshake” at communication start timing. However, an invasion, such as that information stored in the memory of a communication target computer may be obtained without permission, may occur due to an implementation defect of a program that performs the protocol in or even after a communication process. An example widely known in relation to the invasion is a weak point, such as HeartBleed occurred in OpenSSL, that is, an implementation body of TLS in 2014. In order to solve such a problem, in an embodiment, a malicious behavior using an implementation defect, etc. can be prevented in a way that a protocol dialect applicable at handshake start timing of the encryption protocol is added and a server authenticates the protocol dialect.

Furthermore, for example, an application layer protocol (HTTP, etc.) is described. The HTTP is an application layer protocol, and defines a header field having several types of information available for the processing of a request on the server side at the top of a request message transmitted from a client to the server. The header field may be configured at timing at which the client transmits the message. In an embodiment, a certification process may be added to the protocol.

A left figure of FIG. 1 illustrates that several message exchanges are necessary until an initialization process of the existing encryption protocol (TLS, etc.) is completed and a large attack surface is exposed to an attacker. A right figure of FIG. 1 is a technology proposed in an embodiment, and illustrates that an attack surface of an attacker is minimized by adding a certification process at the first timing of a message exchange.

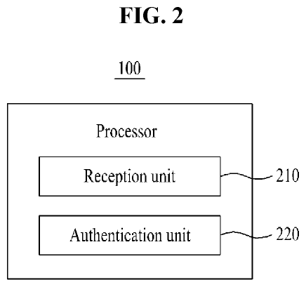

FIG. 2 is a block diagram for describing a configuration of a protocol dialect system in an embodiment.

The protocol dialect system 100 may be disposed between a client and a server in order to certificate and filter out a client by using a message received from the client so as to easily combine a protocol dialect method for security with the existing system. In this case, data available for authenticate by the server may be moved to the protocol dialect system 100, if necessary.

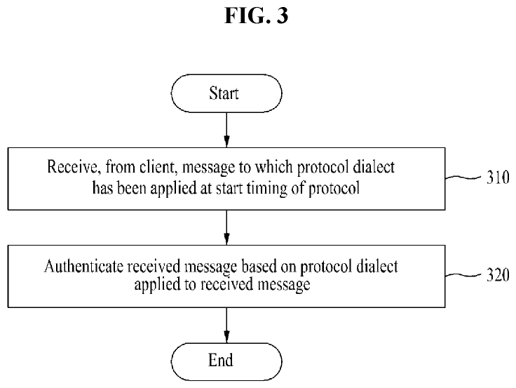

For example, the protocol dialect system 100 may be disposed at a middle point of a network configuration in a form having independent hardware and software separately from the existing system, and may perform the entire protocol dialect operation for security illustrated in FIG. 3. For example, the protocol dialect system 100 may be physically disposed between equipment, such as a firewall or a router that is separately present, and a server system, that is, a protection target.

Furthermore, for example, the protocol dialect system 100 may be implemented in a form embedded in the existing system and additionally executed before the existing encryption protocol is executed, and may perform the entire protocol dialect operation for security illustrated in FIG. 3. Alternatively, the existing system may be network equipment or security equipment to which a function may be added, in addition to a server system, that is, a protection target. For example, the protocol dialect system 100 may be implemented as a part of a software function of unified threat management (UTM) equipment in which several security functions are integrated, and the entire protocol dialect operation for security illustrated in FIG. 3 may be performed.

Furthermore, for example, in the case of an Internet of Things (IoT) apparatus, incomplete security is chiefly provided due to limitations to hardware performance, etc. However, in order to solve such a disadvantage, the protocol dialect system 100 may be implemented in a form embedded in the IoT apparatus.

Furthermore, for example, in order to more easily improve the existing client/server system, the protocol dialect system 100 may be fabricated in a statically or dynamically linkable software library form, if necessary.

Furthermore, for example, the protocol dialect system 100 may be implemented in a network function virtualization (NFV) form available for a cloud environment, a software defined network (SDN) environment, etc.

Referring to FIG. 3, a protocol dialect method for security is described based on the protocol dialect system implemented in a server.

The processor of the protocol dialect system 100 may include a reception unit 210 and a authentication unit 220. Components of the processor may be expressions of different functions performed by the processor in response to a control command provided by a program code stored in the protocol dialect system. The processor and the components of the processor may control the protocol dialect system to perform steps 310 to 320 included in the protocol dialect method for security illustrated in FIG. 3. In this case, the processor and the components of the processor may be implemented to execute instructions based on a code of an operating system stored in a memory and a code of at least one program.

The processor may load, onto the memory, a program code stored in a file of a program for the protocol dialect method for security. For example, when the program is executed in the protocol dialect system, the processor may control the protocol dialect system to load the program code from the file of the program to the memory under the control of an operating system. In this case, the reception unit 210 and the authentication unit 220 may be different functional expressions of the processor for executing subsequent steps 310 to 320 by executing instructions of a corresponding portion of the program code loaded onto the memory.

In step 310, the reception unit 210 may receive, from a client, a message to which a protocol dialect has been applied at the start timing of a protocol. The reception unit 210 may obtain information for the application of the dialect by deriving a certification value or pattern information through at least one method based on a dialect key previously shared between the client and a server. In the case of a transport layer security (TLS) protocol, client random field information, that is, information necessary to calculate a disposable symmetric key to be used between the client and the server, is configured in the message transmitted by the client at communication start timing. The reception unit 210 may determine whether to execute a protocol execution process at the communication start timing of the client by using the configured random field information as information for the application of the dialect. In the case of a TLS protocol, session ID field information for determining whether to reuse a session used between the client and the server is configured in the message transmitted by the client at communication start timing. The reception unit 210 may determine whether to execute a protocol execution process at the communication start timing of the client by using the configured session ID field information as information for the application of the dialect. In the case of a TLS protocol, the reception unit 210 may apply client certification to the message, transmitted by the client at communication start timing, at the communication start timing of the client by using, as information for the application of the dialect, order information of encryption algorithm proposal fields preferred by the client. In the case of an IPSec VPN, Internet key exchange messages are exchanged in order to determine an encryption key to be used between the client and the server. The reception unit 210 may apply client certification at communication start timing of the client by using nonce information, that is, information necessary to determine an encryption key, as information for the application of the dialect. In the case of an IPSec VPN, a vendor ID payload is defined so that software or hardware vendors can identify IKE messages transmitted and received in the systems of the vendors. The reception unit 210 may apply client certification at communication start timing of the client by using the defined vendor ID payload as information for the application of the dialect. In the case of an IPSec VPN, the reception unit 210 may apply client certification at communication start timing of the client by using payload order information of IKE messages as information for the application of the dialect. In the case of an application layer protocol (hypertext transfer protocol (HTTP)), the reception unit 210 may apply client certification at communication start timing of the client by using, as information for the application of the dialect, order information of a plurality of header fields included in a request message transmitted by the client.

In step 320, the authentication unit 220 may authenticate the received message based on the protocol dialect applied to the received message. The authentication unit 220 may authenticate whether the client performs a normal protocol by comparing information for the application of the dialect, obtained using a dialect key previously shared between the client and the server, and a result expected from the message transmitted by the client. The authentication unit 220 can protect the received message against an external factor or an attacker in a communication path by using any one of an additional protection scheme using the received message and a message field of a lower communication layer including the received message, an additional protection scheme using a counter value synchronized between the client and the server, or an additional protection scheme of generating an authentication value by using a communication protocol and characteristics in a path. The authentication unit 220 may generate, on a one off basis, a message to which each protocol dialect has been applied by synchronizing a maximum number of uses and a current number of uses of the dialect key shared between the client and the server. The authentication unit 220 may check field information of the message transmitted by the client at the communication start timing and a hash value of TCP/IP packet header information. The authentication unit 220 can separately protect the dialect key previously shared between the client and the server by using a technology for a trusted execution environment.

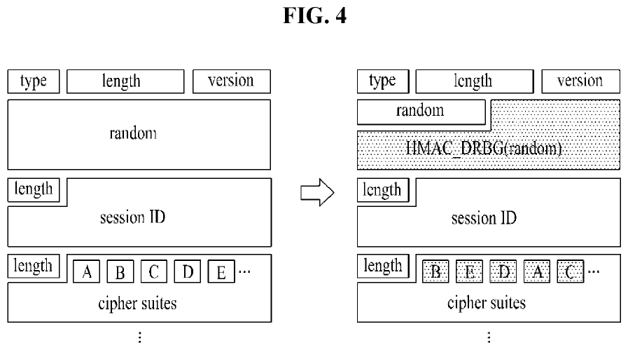

FIGS. 4 to 8 are diagrams for describing a process of applying, by a client, a protocol dialect to a message in an embodiment.

If some of or the entire first message transmitted by a client among several types of protocols operating on an IP can be freely configured, a protocol dialect may be applied to the first message.

The first message (hereinafter referred to as a “Hello message”) transmitted from a client to a server in order to start communication includes several fields. The first message may be modified in order to apply the protocol dialect to some contents of such a field, order of arranged fields, or other characteristics within the limit complying with the specification of a standard protocol.

In this case, information for the application of the dialect may be obtained by deriving a certification value or a pattern from a dialect key previously shared between the client and the server. Only one of operations of exemplary methods described hereinafter may be used or several operations may be applied at the same time. In this case, in order to prevent an external factor (or attacker) in a communication path for a dialect message from attempting an invasion, such as a reuse attack, an operation of protecting the dialect message against an external factor or an attacker in the communication path may be performed.

For example, in the case of a transport layer security (TLS) protocol, client random field information, that is, information necessary to calculate a disposable symmetric key (or session key) to be used between the client and the server, may be configured in a message (i.e., ClientHello message) at the communication initialization (or start) timing of the client. The random field information (or value) is used as only information for calculating the original session key. In contrast, in an embodiment, whether to execute a protocol execution process (client certification, etc.) may be determined at the earliest communication start timing of the client by using the configured random field information as information for the application of the dialect. Referring to FIG. 4, results in which client random field information and encryption preference field information have been applied to a TLS Hello message may be checked.

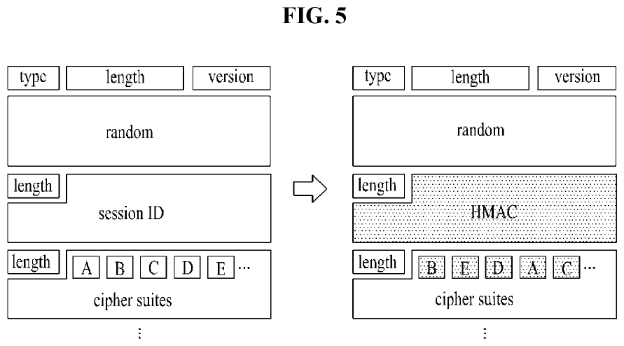

Furthermore, for example, in the case of a TLS protocol, session ID field information (or value) determining whether to reuse a session previously used between the client and the server may be configured in a message (i.e., ClientHello message) transmitted by the client at communication start timing. The session ID field information (or value) is used to only determine whether to reuse the original session. In contrast, in an embodiment, whether to execute a protocol execution process (client certification, etc.) may be determined at the earliest communication start timing by using the configured session ID field information as information for the application of the dialect. Referring to FIG. 5, results in which session ID field information and encryption algorithm preference field information have been applied to a configuration of a TLS Hello message may be checked.

Furthermore, for example, in the case of a TLS protocol, the message (i.e., ClientHello message) includes encryption algorithm proposal field information which may be designated by a sender. Several encryption algorithms are sequentially arranged in the encryption algorithm proposal field information in a order preferred by the sender. Sequence information of an encryption algorithm proposal field means a simple preference order in a conventional technology. However, in an embodiment, order information of encryption algorithm proposal fields preferred by a client may be used as information for the application of a dialect, and client certification may be applied to the order information at the earliest communication start timing.

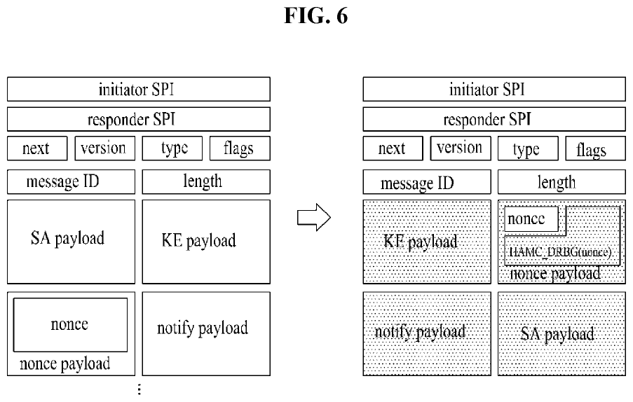

Furthermore, for example, in the case of an IPSec VPN, that is, another encryption protocol, Internet key exchange messages may be exchanged in order to determine an encryption key to be used between a client and a server. The client may include nonce information, that is, information necessary to determine the encryption key, in the message, and may transmit the message to the server. The nonce information is used to only determine the encryption key. In contrast, in an embodiment, the nonce information may be used as information for the application of a dialect, and client certification may be applied to the nonce information at the earliest communication start timing. Referring to FIG. 6, contents (or results) in which a nonce payload value and a field order have been applied to a configuration of the existing IKE message may be checked.

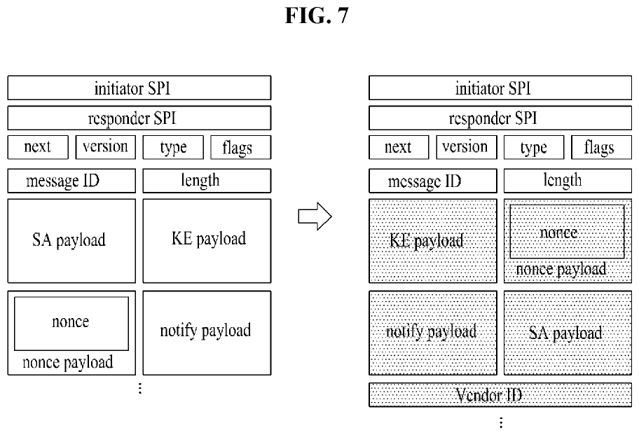

Furthermore, for example, in the IKE, a vendor ID (or vendor ID) payload may be defined so that software or hardware vendors can identify IKE messages transmitted and received in their systems. A payload value is used for the debugging, function extension, etc. of a vendor in a conventional technology. In contrast, in an embodiment, a defined vendor ID payload may be used as information for the application of a dialect, and client certification may be applied to the defined vendor ID payload at the earliest communication start timing. Referring to FIG. 7, results in which a vendor ID payload and a field order have been applied to a configuration of the existing IKE message may be checked.

Furthermore, for example, payloads of the IKE have been defined so that the order of the payloads can be freely designated on the client side. Payload order information has been conventionally determined without special meaning. In contrast, in an embodiment, payload order information of an IKE message may be used as information for the application of a dialect, and client certification may be applied to the payload order information at the earliest communication start timing. In other words, a server may use a order in which payloads of an IKE message are arranged as information that plays a role as a secret key for client certification.

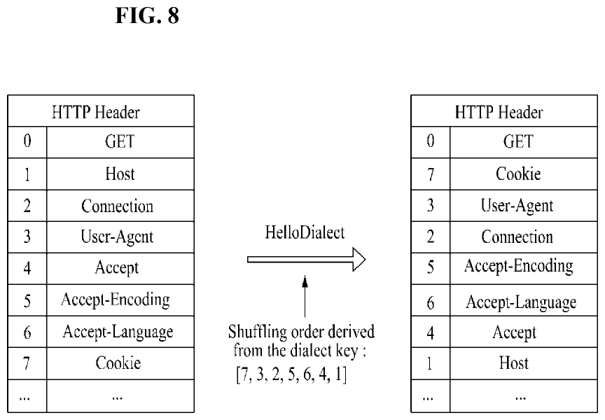

Furthermore, for example, in the case of an application layer protocol (hypertext transfer protocol (HTTP)), several header fields are included at the top of each request message transmitted by a client. Sequence information of a plurality of header fields included in the request message transmitted by the client may be used as information for the application of a dialect, and client certification may be applied to the order information at the earliest communication start timing. Referring to FIG. 8, results in which such header field order information has been applied to a header configuration of the existing HTTP message may be checked.

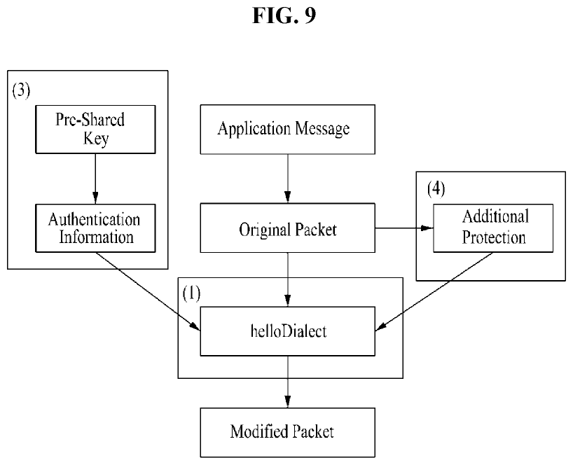

FIG. 9 is a diagram for describing an operation of generating, by a client, a message in an embodiment.

A client may apply a protocol dialect to some of or the entire message. In this case, the client may transmit, to a server, an initial message (“Hello message”) or a request message to which the protocol dialect has been applied by using the method described with reference to FIGS. 4 to 8. The client may transmit, to the server, the message to which the protocol dialect has been applied at the start timing of a protocol.

FIG. 9 illustrates that a client generates a HelloDialect (1) message. The original packet may be generated as a modified packet, including information obtained by an operation (3) of deriving a certification value or pattern from a dialect key previously shared between the client and the server and an operation (4) of protecting a dialect message against an external factor or an attacker in a communication path. The generated modified packet may be transmitted to the server.

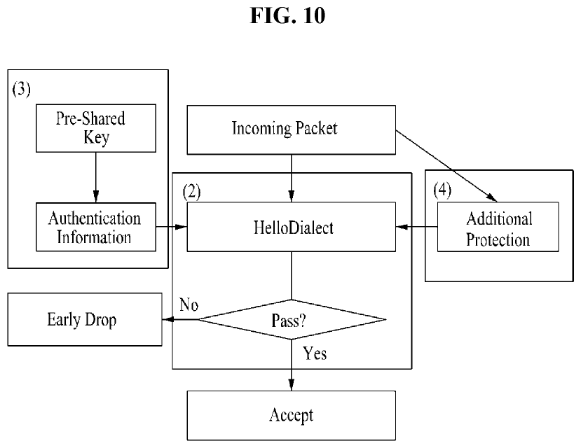

FIG. 10 is a diagram for describing an operation of authenticating, by a server, a message in an embodiment.

A server may receive, from a client, a message to which a protocol dialect has been applied at the start timing of a protocol. The server may authenticate the received message based on the protocol dialect applied to the received message.

FIG. 10 illustrates that the server authenticates (2) a Hellodialect message. The server may determine whether to perform a process after a protocol by comparing a packet, received from the client, information obtained by an operation (3) of deriving a certification value or pattern from a dialect key previously shared between the client and the server and an operation (4) of protecting a dialect message against an external factor or an attacker in a communication path.

The operation (3) of deriving the certification value or pattern from the dialect key previously shared between the client and the server is described. The dialect key shared between the client and the server may be used to generate a value or information to be used in an operation of applying a protocol dialect to a message at the start timing of a protocol and a process of authenticating a message based on a protocol dialect applied to the message.

For example, a result value obtained as a previously shared key is used as an input to a cryptological function, such as HMAC, may be used in a process of applying a protocol dialect to a message at the start timing of a protocol and a process of authenticating the message based on the protocol dialect applied to the message. An invader cannot perform normal protocol dialect communication because the invader cannot easily predict a result value unless the invader knows input data including a previously shared key.

Furthermore, for example, a result value obtained as a previously shared key is used as an input to a function for generating order or progression may be used in a process of applying a protocol dialect to a message at the start timing of a protocol and a process of authenticating the message based on the protocol dialect applied to the message.

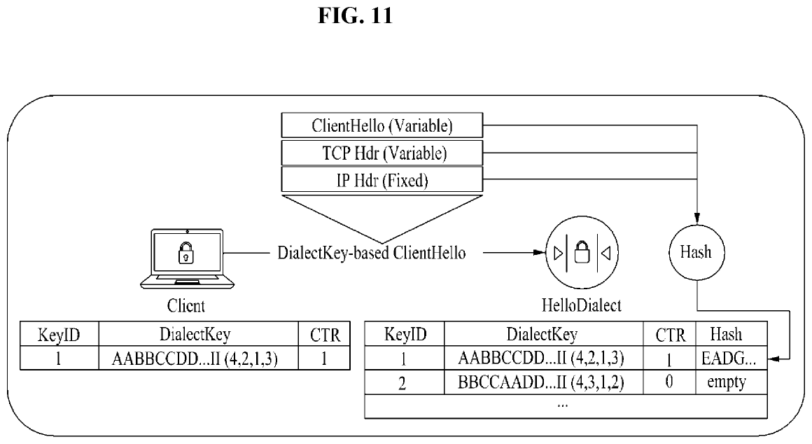

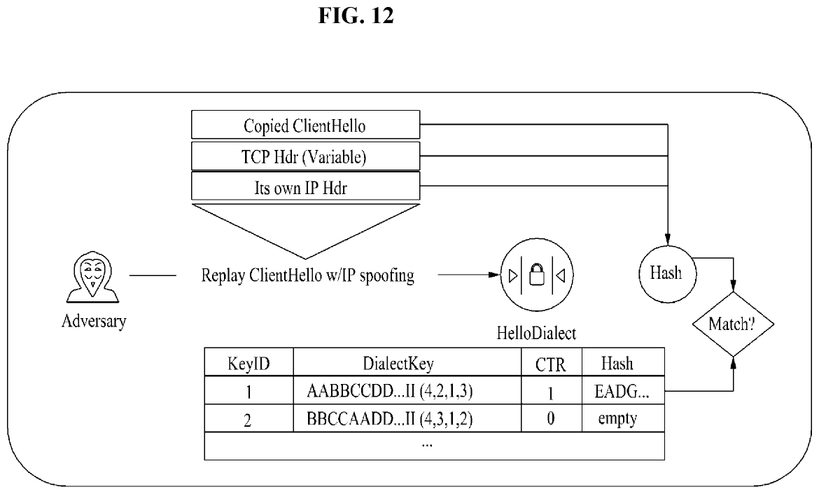

FIGS. 11 to 12 are diagrams for describing an operation of protecting a message against an external factor or an attacker in a communication path in an embodiment.

In order to prevent an invasion into a dialect message itself transmitted between a server and a client, in an embodiment, an additional protection scheme may be introduced. In this case, the dialect message may mean a message to which a protocol dialect has been applied by a client. The additional protection scheme may include a method using the dialect message and a message field of a lower communication layer including the dialect message, a method using a counter value synchronized between a client and a server, a method of generating an authenticate value that is difficult to be randomly manipulated by an invader by using characteristics in a communication protocol and a path, etc.

For example, a reuse attack in which an attacker in a communication path between a server and a client stores a dialect message transmitted by the client without change and then delivers corresponding contents to the server without change in order to disguise himself or herself in a correct client may occur. In order to prevent such a problem, in an embodiment, each dialect message may be generated on a one off basis by synchronizing a maximum number of uses and a current number of uses of a dialect key between the server and the client.

Furthermore, for example, in order to prevent an attacker in a communication path from disguising himself or herself in a correct client by modifying some (e.g., an IP address) of a dialect message and then from intercepting communication, a method of identifying a field of a Hello message and a hash value, such as a TCP/IP packet header, may be included in a process of applying a protocol dialect to the message at the start timing of a protocol, a process of authenticating the message based on the protocol dialect applied to the message, or a process of deriving a certification value or pattern from a dialect key previously shared between a client and a server.

Referring to FIG. 11, in order to prevent an invasion occurring because an invader in a communication path copies a packet to which a protocol dialect has been applied, stores the packet, and then detours the protection of a dialect message (HelloDialect) by inserting an IP address/port number of the invader into the packet instead, the aforementioned additional protection scheme (example) may be applied.

Referring to FIG. 12, an invader attempts to detour a dialect message (HelloDialect) by inserting its own IP address into a copied packet, but such an invasion may be detected because a hash value of a forged packet is different from a hash value expected by a server.

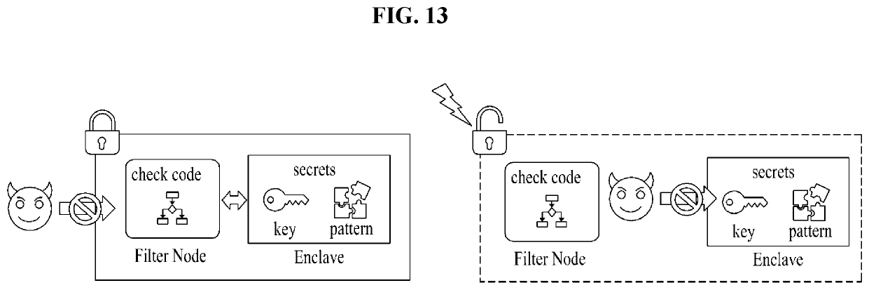

FIG. 13 is a diagram for describing an operation of protecting a previously shared dialect key against a user, server management or other factors in an embodiment.

An additional method for protecting a program and data that perform each process so that the program and the data are not exposed by another factor (a managerial or technical defect, etc.) may be combined with an operation of applying a protocol dialect to a message at the start timing of a protocol, an operation of authenticating the message based on the protocol dialect applied to the message, an operation of deriving a certification value or pattern from a dialect key previously shared between a client and a server, and an operation of protecting the message against an external factor or an attacker in a communication path. Specifically, a program and data for an embodiment may be stored and computed in an environment isolated from an operating system or another factor within a system by using a technology for a trusted execution environment (TEE) provided by a manufacturer of a central processing unit (CPU).

Although a third party having system control rights, such as the owner, manager, etc. of a device applied to an embodiment, is different from a user who uses the present disclosure, a dialect key, software that has implemented an embodiment, etc. can be protected using the program and data so that the dialect key or the software is not exposed to the third party. For example, information related to a dialect can be protected by separating the dialect key or the software from another element (e.g., an untrusted device manager or an untrusted operating system or other software) of a device to which an embodiment has been applied by using software guard extension (SGX) of Intel Corporation or TrustZone of ARM Ltd.

Referring to FIG. 13, if an invader has not dominated a protocol dialect system, information, such as a previously shared key used in a process described in an embodiment, cannot leak. However, in order to prevent the possibility that information, such as a previously shared key, may leak after the invader who has abused a managerial or technical defect, etc. dominates the protocol dialect system, a method using software guard extension (SGX) of Intel Corporation or TrustZone of ARM Ltd. may be applied. Important information cannot leak although the invader uses the defect because the important information is stored separately from other elements in the system.

According to an embodiment, the protocol dialect system and method may be commonly used to protect all types of computing that perform an interaction between a client and a server previously authenticated.

According to an embodiment, the protocol dialect system and method may be used if a key or a configuration for previous authentication can be shared with a client that accesses a server. Accordingly, if the identity of a requester who tries to access the server can be easily identified previously, additional protection can be provided by applying the present disclosure. As a detailed example, a client trying to access a service for the manager of a server needs to be a predetermined manager. In a generic case, a method, such as a private key file or a password for manager certification, is used. In such a method, however, as described in Summary, when a defect occurs in a protocol implementation, a certification process may be detoured or information necessary for certification may leak. If the technology proposed in an embodiment is applied, traffic that attacks such a defect at the start timing of a certification process can be effectively blocked.

According to an embodiment, the protocol dialect system and method may be easily applied to the present protocols (IKE for IPSec VPN, TLS/SSL, and HTTP(S)).

Furthermore, the protocol dialect system and method may also be easily applied to provide additional protection even in an internal network environment of a company, a hospital, or a campus in addition to a public network, such as the Internet.

Furthermore, the protocol dialect system and method may be used to provide additional security even in an environment in which it is difficult to patch or update a protocol implementation due to several types of restrictions. For example, in the case of a low energy Internet of Things (IoT) apparatus, it may be difficult to update software that has implemented a protocol, etc. due to restricted hardware performance and a restricted network bandwidth. In such a case, a potential security defect can be supplemented by adding a process of authenticating the owner of an apparatus by applying the technology proposed in an embodiment.

The aforementioned apparatus may be implemented as a hardware element, a software element and/or a combination of a hardware element and a software element. For example, the apparatus and components described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. A processing apparatus may perform an operating system (OS) and one or more software applications executed on the OS. Furthermore, the processing apparatus may access, store, manipulate, process and generate data in response to the execution of software. For convenience of understanding, one processing apparatus has been illustrated as being used, but a person having ordinary knowledge in the art may understand that the processing apparatus may include a plurality of processing components and/or a plurality of types of processing components. For example, the processing apparatus may include a plurality of processors or one processor and one controller. Furthermore, other processing configurations, such as a parallel processor, are also possible.

Software may include a computer program, a code, an instruction or a combination of one or more of them, and may configure a processor so that it operates as desired or may instruct processors independently or collectively. Software and/or data may be embodied in any type of a machine, component, physical device, virtual equipment, or computer storage medium or device so as to be interpreted by the processor or to provide an instruction or data to the processor. The software may be distributed to computer systems connected over a network and may be stored or executed in a distributed manner. The software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure alone or in combination. The program instructions stored in the medium may be specially designed and constructed for the present disclosure, or may be known and available to those skilled in the field of computer software. Examples of the computer-readable storage medium include magnetic media such as a hard disk, a floppy disk and a magnetic tape, optical media such as a CD-ROM and a DVD, magneto-optical media such as a floptical disk, and hardware devices specially configured to store and execute program instructions such as a ROM, a RAM, and a flash memory. Examples of the program instructions include not only machine language code that is constructed by a compiler but also high-level language code that can be executed by a computer using an interpreter or the like.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and the equivalents of the claims fall within the scope of the claims.

The embodiments of the invention in which an exclusive property or privilege is claimed are defined as follows:

1. A protocol dialect method for security performed by a protocol dialect system, comprising:
receiving, from a client, a message to which a protocol dialect has been applied at communication start timing of a protocol; and
authenticating the received message based on the protocol dialect applied to the received message.

2. The protocol dialect method of claim 1, wherein receiving the message comprises obtaining information for the application of the dialect by deriving a certification value or pattern information through at least one method by using a dialect key previously shared between the client and a server.

3. The protocol dialect method of claim 2, wherein:
in a case of a transport layer security (TLS) protocol, client random field information which is information necessary to calculate a disposable symmetric key to be used between the client and the server is configured in the message transmitted by the client at the communication start timing, and
receiving the message comprises determining whether to execute a protocol execution process at the communication start timing of the client by using the configured random field information as the information for the application of the dialect.

4. The protocol dialect method of claim 2, wherein:
in a case of a transport layer security (TLS) protocol, session ID field information for determining whether to reuse a session used between the client and the server is configured in the message transmitted by the client at the communication start timing, and
receiving the message comprises determining whether to execute a protocol execution process at the communication start timing of the client by using the configured session ID field information as the information for the application of the dialect.

5. The protocol dialect method of claim 2, wherein in a case of a transport layer security protocol, receiving the message comprises applying client certification to the message, transmitted by the client at the communication start timing, at the communication start timing of the client by using, as the information for the application of the dialect, order information of encryption algorithm proposal fields preferred by the client.

6. The protocol dialect method of claim 2, wherein:
in a case of an IPSec VPN, Internet key exchange messages are exchanged in order to determine an encryption key to be used between the client and the server, and
receiving the message comprises applying client certification at the communication start timing of the client by using nonce information which is information necessary to determine an encryption key, as the information for the application of the dialect.

7. The protocol dialect method of claim 2, wherein:
in a case of an IPSec VPN, a vendor ID payload is defined so that software or hardware vendors are capable of identifying IKE messages transmitted and received in systems of the vendors, and
receiving the message comprises applying client certification at the communication start timing of the client by using the defined vendor ID payload as the information for the application of the dialect.

8. The protocol dialect method of claim 2, wherein in a case of an IPSec VPN, receiving the message comprises applying client certification at the communication start timing of the client by using payload order information of IKE messages as the information for the application of the dialect.

9. The protocol dialect method of claim 2, wherein in a case of an application layer protocol (hypertext transfer protocol (HTTP)), receiving the message comprises applying client certification at the communication start timing of the client by using, as the information for the application of the dialect, order information of a plurality of header fields included in a request message transmitted by the client.

10. The protocol dialect method of claim 2, further comprising providing a result value obtained by using the dialect key shared between the client and the server as an input to a cryptological function or an input to a function for generating order or progression so that the result value is used in receiving the message and authenticating the received message.

11. The protocol dialect method of claim 1, wherein authenticating the received message comprises authenticating whether the client performs a normal protocol by comparing information for the application of the dialect obtained using a dialect key previously shared between the client and a server with a result expected from the message transmitted by the client.

12. The protocol dialect method of claim 11, wherein authenticating the received message comprises protecting the received message against an external factor or an attacker in a communication path by using any one of an additional protection scheme using the received message and a message field of a lower communication layer comprising the received message, an additional protection scheme using a counter value synchronized between the client and the server, or an additional protection scheme of generating an authentication value by using a communication protocol and characteristics in a path.

13. The protocol dialect method of claim 12, wherein authenticating the received message comprises generating, on a one off basis, a message to which each protocol dialect has been applied by synchronizing a maximum number of uses and a current number of uses of the dialect key shared between the client and the server.

14. The protocol dialect method of claim 12, wherein authenticating the received message comprises checking field information of the message transmitted by the client at the communication start timing and a hash value of TCP/IP packet header information.

15. The protocol dialect method of claim 1, wherein authenticating the received message comprises separately protecting a dialect key previously shared between the client and a server by using a technology for a trusted execution environment.

16. A computer program stored in a computer-readable storage medium in order to execute a protocol dialect method for security performed in a protocol dialect system, the computer program comprising:
receiving, from a client, a message to which a protocol dialect has been applied at start timing of a protocol; and
authenticating the received message based on the protocol dialect applied to the received message.

17. A protocol dialect system for security, comprising:
a message reception unit configured to receive, from a client, a message to which a protocol dialect has been applied at start timing of a protocol; and
an authentication unit configured to authenticate the received message based on the protocol dialect applied to the received message.

18. The protocol dialect system of claim 17, further comprising a derivation unit configured to obtain information for the application of the dialect by deriving a certification value or pattern information through at least one method by using a dialect key previously shared between the client and a server.

19. The protocol dialect system of claim 17, further comprising a protection unit configured to protect the received message against an external factor or an attacker in a communication path by using any one of an additional protection scheme using the received message and a message field of a lower communication layer comprising the received message, an additional protection scheme using a counter value synchronized between the client and the server, or an additional protection scheme of generating an authentication value by using a communication protocol and characteristics in a path.

20. The protocol dialect system of claim 17, further comprising a key protection unit configured to separately protect a dialect key previously shared between the client and a server by using a technology for a trusted execution environment.
